(19) United States
(12) Patent Application Publication
(10) Pub. No.: US 2019/0362353 A1
(43) Pub. Date: Nov. 28, 2019

(54) SYSTEMS AND METHODS FOR INTERPRETING ANALYTICAL RESULTS

(71) Applicant: International Business Machines Corporation, Armonk, NY (US)

(72) Inventors: Willie R. Patten, JR., Hurdle Mills, NC (US); Eugene I. Kelton, Mechanicsburg, PA (US); Yi-Hui Ma, Mechanicsburg, PA (US)

(21) Appl. No.: 15/988,664

(22) Filed: May 24, 2018

(51) Int. Cl. G06Q 20/40; G06N 5/02; G06Q 40/02; G06F 17/27; G06F 17/18

(52) U.S. Cl. CPC G06Q 20/4016; G06N 5/022; G06F 15/18; G06F 17/2785; G06F 17/18; G06Q 40/02

(57) ABSTRACT

The present application relates to systems far interpreting analytical results and methods for using the same. The systems and methods generally comprise a result interpreter system and input information provided by a user. The system generates one or more reports that use analytical and visual information to interpreting the analytical result to the user.

### FIELD

The present application generally relates to systems for interpreting the results of an analytical process and methods for using the same.

### BACKGROUND

Advanced analytical tools are important to a range or fields and industries. For example, various analytical methods are used to detect banking fraud, aid in regulatory compliance, determine how to best apply marking results, and many other complex, data-driven problems. Traditionally, the evaluation of analytical results is mostly based on simple statistical metrics, such as false positive rate, true punitive rales, and measurements of precision and error. Other evaluation techniques include basic estimations, such as simple linear regression, to help to explain more complex models. However, newer analytical tools are ever more advanced in both their power and complexity. Many current tools, such a machine learning technics and combination approaches that combine several analysis models, produce results that are difficult to understand and explain, even when the end user has advanced technical training. Understanding how analytical results were reached is critical in building trust in the system, and in some cases, such as regulatory compliance, such understanding is a necessity. Thus, what is needed is a method interpreting analytical results hi allow an end user to gain understanding of those results, regardless of their complexity

### SUMMARY

Embodiments herein provide a computer implemented method in a data processing system comprising a processor and a memory comprising instructions which are executed by the processor to cause the processor to implement a system for interpreting analytical results. In some embodiments, the method comprises: receiving, by the system, input information comprising the analytical results to be interpreted; determining, by the system, analytic elements of the input information; wherein the analytic elements comprise: a problem domain of the input information, key data elements of the input information, computed features of the input information, applicable models for the analysis of the input information; and relevant visualizations of the applicable models; generating; by the system, the results of the analytic elements; generating, by the system, an output report on the results of the analytic elements; and transmitting, by the system, the output report to a user.

Embodiments herein also provide a system for interpreting analytical results, comprising: a result interpreter system; a natural language generator; and a memory comprising instructions which are executed by a processor. In some embodiments, the processor is configured to: receive, by the system for interpreting analytical results, input information comprising the analytical results to be interpreted; determine, by the result interpreter system, analytic elements of the input information: generate, by the result interpreter system, the results of the analytic dements; generate, by the natural language (generator, an output report on the results of the analytic elements; and transmit, by the system for interpreting analytical results, the output report to a user.

In some embodiments, the analytic elements comprise: a problem domain of the input information, key data elements of the input information, computed features of the input information, applicable models for the analysis of the input information, and relevant visualizations of the applicable models.

In some embodiments, the input information further comprises the problem domain and a data set. In some embodiments, the data set was used to generate the analytical results to be interpreted. In some embodiments, the computed features of the input information comprise one or more of model complexity, model scope, and model trust. In some embodiments, the step of generating an output report on the results of the analytic elements is performed by the natural language generator.

Additional features and advantages of this disclosure will be made apparent from the following detailed description of illustrative embodiments that proceeds with reference to the accompanying drawings.

### BRIEF DESCRIPTION OF THE DRAWINGS

The foregoing and other aspects of the present disclosure are best understood from the following detailed description when read in connection with the accompanying drawings. For the purpose of illustrating the disclosure, there is shown in the drawings embodiments that are presently preferred, it being understood, however, that the disclosure is not limited to the specific embodiments disclosed.

FIG. 1 depicts a block diagram of an exemplary system for interpreting analytical results;

FIG. 2 depicts a flow chart of an exemplary method of using the system for interpreting analytical results; and

FIG. 3 depicts a block diagram of an example data processing system in which aspect of the illustrative embodiments may be implemented.

### DETAILED DESCRIPTION OF THE EMBODIMENTS

The present description and claims may make us of the terms “a,” “at least one of,” and “one or more of,” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within in the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit, and scope of the present disclosure.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, on electromagnetic storage device, a semiconductor storage device, or any suitable combination of the foregoing. A non-exhaustive list of more specific examples of the computer readable storage medium includes the following: a portable computer diskette, a head disk, a random access memory (RAM), a read-only memory (ROM), on erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN) and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages, the computer readable program instructions may execute entirely on the user's computer, partly on the user's computer, as a stand-along software package, partly on the user's computer and partly on a remote computer, or entirely on the remote computer or server. In the latter scenario, the remote computer may be connected to the user's computer through any type of network, including LAN or WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided in a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that con direct a computer, a programmable data processing apparatus, and/or other devices to function in a particular manner, such that the computer readable storage medium having instructions stored therein comprises an article of manufacture including instructions which implement aspects of the function/act specified to the flowchart and/or block diagram block or blocks.

The computer readable program instructions may also be loaded onto a computers other programmable data processing apparatus, or other device to cause a series of operations steps to be performed on the computer, other programmable apparatus, or other device to produce a computer implemented process, such that the instructions which execute in the computer, other programmable apparatus, or other device implement the functions/acts specified in the flowchart and/or block, diagram block or blocks.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As an overview, a cognitive system is a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with high accuracy and resilience on a large scale. IBM Watson™ is an example of one such cognitive system which can process human readable language and identify inferences between text passages with human-like accuracy at speeds far faster than human beings and on a much larger scale. In general, such cognitive systems are able to perform the following functions:

Navigate the complexities of human language and understanding

Ingest and process vast amounts of structured and unstructured data

Generate and evaluate hypotheses

Weigh and evaluate responses that are based only on relevant evidence

Provide situation-specific advice, insights, and guidance

Improve knowledge and learn with each iteration and interaction through machine learning processes

Enable decision making at the point of impact (contextual guidance)

Scale in proportion to the task

Extend and magnify human expertise and cognition

Identify resonating, human-like attributes and traits from natural language

Deduce various language specific or agnostic attributes from natural language

High degree of relevant recollection from data points (images, text, voice) (memorization and recall)

Predict and sense with situation awareness that mimic human cognition based on experiences

Answer questions based on natural language and specific evidence

Embodiments herein relate to a system for interpreting the results of an analytical process. The system receives analytical results and generates information relating to how the analytical process achieved those results, and what those result mean in the context of the problem. In some embodiments, the information generated from the system is further processed into a written document, such as a report. In some embodiments, the system utilizes natural language generation to convert the generated information into understandable text.

In some embodiments, the system for interpreting analytical results is a stand-alone system that receives analytical results from an external process, system, or user. In some embodiments, the system for interpreting analytical results is itself a component or subsystem of a larger analytical system. For example, a larger analytical system generates analytical results to a user-defined problem, then the system for interpreting analytical results further processes those results and generates information relating to how those results were achieved and what those result mean in the context of the problem. A final output report is presented to the user with both the analytical results themselves and their interpretation.

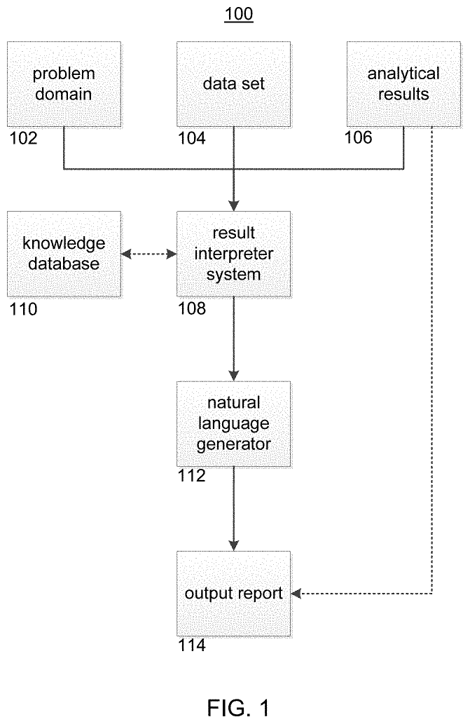

FIG. 1 depicts a block diagram representation of components, outputs, and data flow of an exemplary system for interpreting analytical results 100. To begin, the system needs certain pieces of information from a previously completed analytical process. The first piece of information the system requires is the problem domain 102, which may include a specific problem, issue, or task that a user ran the previously completed analytical process to solve. In some embodiments, the problem domain 102 also includes the general area or field of the specific problem, issue, or task. In some embodiments, the problem domain 102 includes one or more keywords that are related to the specific problem, issue, or task. In some embodiments, the problem domain 102 is in or related to financial information. In some embodiments, the problem domain 102 is in or related to fraud detection.

The second piece of information the system requires is the data set 104 that was analyzed by the previously completed analytical process. In some embodiments, the data set 104 is a collection of information that the user has identified as being relevant to the problem domain 102. In some embodiments, the data set 104 is a collection of data available to a user, whether relevant to the problem domain 102 or not. In some embodiments, the data set 101 is combination of information provided by a user and information provided one or more third-parties, such as an external data store, public domain information, or information provided by on analytical system. For example for problem domains related to financial transactions, the data set 104 might contain transactional records, contact numbers, account numbers, transaction ID, transaction amounts, currencies, and more.

Another piece of information the system requires is the analytical results 106 of the previously completed analytical process. In some embodiments, the analytical results 106 will comprise the mathematical output of the analytical process. In some embodiments, the analytical results 106 will comprise a list of answers from the analytical process, for example, a list of names or transactions. In some embodiments, the analytical results 106 will comprise a binary or graded response, for example, yes/no, true/false, or low/medium/high. In some embodiments, the analytical results 106 will further comprise information on one or more of the analytical model or models that were completed, the element of the data set 104 that were utilized, who selected the analytical model or models that were used, and the standard error or variance of the mathematical output.

Once the problem domain 102, the data set 104, and the analytical results 106 have been imputed into the system for interpreting analytical results 100, the information is passed to the result interpreter system 108. The result interpreter system 108 analyzes the analytical results 106, in light of the problem domain 102 and the data set 101, and produces advanced metrics that help to explain how the analytical process achieved the analytical results 106, and what the analytical results 106 mean in the context of the problem domain 102. In some embodiments, the result interpreter system 108 analyzes the analytical results 106 by determining one or more of model complexity, model scope, and model trust

In some embodiments, model complexity is an analysis of the complexity of the previously completed analytical process. For example, most analytical models are generally understood to be, in increasing order of complexity, linear and monotonic, nonlinear and monotonic, or nonlinear and non-monotonic. Further, many models use a variety of mathematical techniques, such as linear regression, random forest, and k-means, and some models are inherently more complex than others. Additionally, single models, even highly complex single models, are often lower in overall complexity that analytical systems that utilize multiple models.

In some embodiments, model scape is an analysis of how much and which parts of the data set 104 was used by the previously completed analytical process in determining the analytical results 106. For example, most analytical models are either local or global in scope. Local models use only parts of the data set 104 in producing the analytical results 106, while global models use the entire data set 104. Typically, local models are easier to interpret than global models

In some embodiments, model trust is the degree of understanding a typical user of the analytical results 106 has in the completed analytical process used to generate those results, in some embodiments, models that are lower in complexity and more local in scope have a higher degree of trust. In some embodiments, models that are higher in complexity and more global in scope have a lower degree of trust. In some embodiments, the use of graphical or other visual means to show characteristics of the analytical results 106 provides increased model trust.

In some embodiments, the result interpreter system 108 optionally communicates with a knowledge database 110. The knowledge database 110 comprises a historical database of previously interpreted analytical results. In some embodiments, the knowledge database 110 comprises complete or partial information regarding the problem domains, data sets, and analytical results from previously interpreted analytical results. In some embodiments, the knowledge database 110 comprises one or more of the model complexity, model scope, and model trust results previously generated by the result interpreter system 108. In some embodiments, the result interpreter system 108 communicated with the knowledge database 110 to compare currently generated interpretations with historical counterparts. For example, the result interpreter system 108 determines that the analytical results 106 were nonlinear but monotonic, but the knowledge database 110 indicates that historically, analytical models similar or identical to the analytical models used to generated the analytical results 106 produce results that were linear and monotonic. This deviation from previously seen results can be an indication that additional interpretation or further analysis is required, for example, that the originally applied analytical models used the generation the analytical results 106 were inadequate to explain true relationships in the data set 104. In some embodiments, the result interpreter system 108 uses one or more entries in the knowledge database 110 individually. In some embodiments, the result interpreter system 108 performs further analysis on the entries in the knowledge database, such as but not limited to summation, averaging, regression analysis. Or other statistical techniques. In some embodiments, the knowledge database 110 can be updated with the results of the result interpreter system 108.

In some embodiments, the knowledge database 110 is a collection of previously analyzed results of the same model over time. For example, the results of a continually running analysis model are run through the system for interpreting analytical results 100 at regular intervals. The knowledge database 100 would be a historical collection of each interpretation run, such that each new interpretation run can be analyzed to detect deviations or convergences of the data in comparison with the historical trends. If the current interpretation analysis, or the last few analyses, show a trend away from a historical average or trend, that difference can be recognized by the result interpreter system 108. The result interpreter system 108 can then perform additional analysis on the evolving trend to determine which elements of the dataset 104 are causing the difference.

Once the result interpreter system has completed its analysis, with or without the optional communication with the knowledge database 110, the results are passed to a natural language generator 112, which processes the results into an output report 114. Natural language generators are known in the art, and are generally capable of converting non-text elements into an understandable, text-based format. In some embodiments, the natural language generator 112 converts the completed mathematical, keyword, and graphical analysis from the result interpreter system 108 into a readable text-based output for use in the output report 114. In some embodiments, the output report 114 is the output of the natural language generator 112. In some embodiments, the output report 114 is the combination of the out of the natural language generator 112 and the original analytical results 106. In some embodiments, the output report 114 highlights the key elements of the analysis of the result interpreter system 108. In some embodiments, the output report 114 is capable of being understood by an end user with a layman understanding of the analytical techniques, models and analysis involved with the interpretation of the original analytical results 106. In some embodiments, the output report 114 highlights key pieces of analytical information necessary to satisfy regulatory requirements. In some embodiments, the output report 114 is presented in a graphical user interface.

In some embodiments, the components of the system for interpreting analytical results 100 can be stored in the same location, for example, as installed software in an internal server system at a company, such as a bank. In some embodiments, some of the components of the system for interpreting analytical results 100 are stored in different locations, such as part of a cloud-based service. For example, a company, such as a bank, can upload the problem domain 102, the data set 104, and the analytical results 106 to a cloud-based system which contains the result interpreter system 108, knowledge database 110, and natural language generator 112. The output report 114 can then be downloaded by the company when complete. In some embodiments, the problem domain 102, the data set 104, and the analytical results 106 can remain stored in a location, while access to them can be provided. For example, problem domain 102, the data set 101, and the analytical results 106 are stored in an internal server system at a bank, and electronic access to them is provided, such that the result interpreter system 108, knowledge database 110, and natural language generator 112, which are stored in a different location, can complete their analysis.

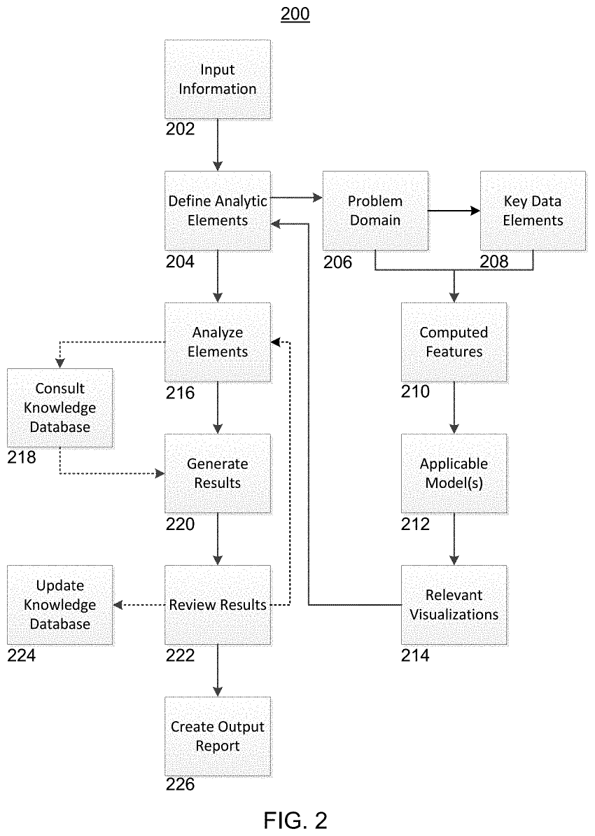

FIG. 2 depicts a flow chart of an exemplary method of using the system described herein 200. First, a user inputs the information to system 202, such as the problem domain, data set, and analytical results that to be interpreted. In some embodiments, the information can be selected from any type of information or data disclosed herein. In some embodiments, the information is not physically inputted into the system, but rather the system has electronic access to the information.

Once the use inputs the information into the system 202, the user instructs the system to interpreted the analytical results. The system begins by defining the analytic elements of the information inputted by the user 204. First, the system defines and analyzes the problem domain of the analysis 206. In some embodiments, the problem domain has been previously defined by the user. In some embodiments, the system identifies applicable analytical techniques, models, and algorithms that are commonly used in the problem domain. Second, the system defines the key data elements 208 of the information inputted by the user. In some embodiments, the key data elements 208 comprise the entirety of the data set inputted by the user. In some embodiments, the key data elements 208 comprise portions of the complete data set that were used to determine the analytical results that are currently being interpreted. In some embodiments, the key data elements 208 comprise data elements commonly associated with the problem domain.

Once the system has defined the problem domain 206 and the key data elements 208, the system computes the features of the information 210. In some embodiments, the computed features comprise one or more of the model complexity, model scope, and model trust as defined herein. In some embodiments, the computed features are determined by at least one algorithm. In some embodiments, the at least one algorithm comprises a machine learning algorithm. Based on the computer features 210, the system then produces more or more applicable analytical models than can be used to analyze the information inputted by the user 212. In some embodiments, the system uses one or more algorithms to determine which analytical model or models would best be used in interpreting the previously obtained analytical results. In some embodiments, the system uses one or more tables to determine which analytical model or models would best be used in interpreting the previously obtained analytical results. In some embodiments, the applicable model or models comprise models that can best interpret and analytical results. In some embodiments, the applicable model or models comprise techniques that approximate the previously obtained analytical results, such as various regression or best fit methods. In some embodiments, the applicable model or models comprise models that the system identifies as the best models to compute the previously obtained analytical results. In some embodiments, the applicable model or models are identical to the analytical model or models used to calculate the previously obtained analytical results. In some embodiments, the applicable model or models are not identical to the analytical model or models used to calculate the previously obtained analytical results.

Once the system has selected one or more applicable models 212, the system will then select relevant visualizations that best allow the applicable models to be easily understood 214. In some embodiments, the relevant visualizations comprise graphical or other visual elements that are commonly associated with a certain applicable model or class of applicable models. A person skilled in the art will appreciate that there is a wide variety of model visualizations that can be used to visually represent various analytical models. In some embodiments, the relevant visualizations can include, but are not limited to, glyphs, correlation, graphs, 2-D projections, principal component analysis, multidimensional scaling, t-distributed stochastic neighbor embedding, auto encoder networks, partial dependence plots, and residual analysis. In some embodiments, the relevant visualizations will be various regression or fit methods that approximate the applicable model or models to aid the in interpretation of complex models, for example, machine, learning models or other non-linear, non-monotonic models. In some embodiments, the relevant visualizations can include, but are not limited to, ordinary least squares, penalized regressions, generalized additive models, quantile regressions, and gated linear models. In some embodiments, the relevant visualizations will be graphical representations of sections or pieces of the applicable model or models, that, when presented to a user, collectively aid in the interpretation of the entire model. For example, breaking a complex, non-linear function into several localized linear functions. In some embodiments, the relevant visualizations will be transformed variants of the applicable model or models that reduce the complexity of the applicable model or models in a way that aids in the interpretation of the non transformed model. For example, placing monotonicity constraints on a non-linear, non-monotonic model to orient the model around variable relationship known to be true, or the utilization of monotonic neural networks for machine learning applications. In some embodiments, the relevant visualizations will be related but less complex models that approximate the applicable model or models to aid in the interpretation of the original complex models, especially machine learning models. For example, surrogate models, local interpretable model-agnostic explanations (LIME), maximum activation analysis, and sensitivity analysis. In some embodiments, the relevant visualizations will be visual illustrations of certain key elements or variables of the applicable model or models. For example, global variable importance, leave-one-covariate-out (LOCO), and visual representations of key paths on a decision tree.

Once the system has chosen the applicable models 212 and the relevant visualizations 214, the analytic elements are fully defined 204 and the system can analyze those elements 216. When analyzing the analytic elements, the system is not re-running the originally performed analysis or model, but rather analyzing the specific analytic elements determined in steps 206 to 214. For example, the system will perform the specific analytical models and relevant visualizations previously selected. In some embodiments, the system can optionally communicate and consult with the knowledge database 218 to compare the analysis with historical information. In some embodiments, the knowledge database 218 is selected from any type of knowledge database disclosed herein.

After the system has completed the analysis of the defined elements 216 and optionally communicated with the knowledge database 218, the system generates the results from the analysis 220. The system generates key facts about the input information 202, including, for example, numeric and statistical indicators on the characteristics of the input information 202 in general and the specifics of the results generated in the analysis step 216. Once the results are generated 220, they can be reviewed 222. In some embodiments, the result review 222 is conducted by a human operator. In some embodiments, the human operator is the user who performed the input information step 202. In some embodiments, the human operator is not the user who performed the input information step 202. In some embodiments, the result review 222 is conducted by computer analysis, such as a specifically trained machine learning program. In some embodiments, the result review 222 allows feedback into the system, for example, by indicating if certain results nonsensical or confusing. In some embodiments, the system can return to the analyze elements step 216 if the results review 222 indicates that changes in the analysis are necessary. In some embodiments, the system can communicate with the knowledge database to update the database based on the current results 224.

Finally, when the analytic results have passed review 222 and optionally the database has been updated 224, the system proceeds to create the output report 226. In some embodiments, a natural language generator is used to create the output report based on the analytical results. In some embodiments, the natural language generator is selected from any type of natural language generator disclosed herein.

In some embodiments, the input information step 202 is performed by a user, and comprises at least the problem domain 102, data set 104, and the analytical results to be interpreted 106. In some embodiments, the steps of define analytic elements 204, problem domain 206, key data elements 208, computer features 210, applicable models 212, relevant visualizations 214, analyze elements 216, and generate results 220 are performed by the result interpreter system 108. In some embodiments, the optional steps of consulting the knowledge database 218 and updating the knowledge database 224 are performed by the result interpreter system 108 in communication with the knowledge database 110. In some embodiments, the step of review results 222 is performed by a user or the result interpreter system 108. In some embodiment, the create output step 226 is performed by the natural language generator 112 and produces the output report 114.

In some embodiments, the user of any of the systems disclosed herein can be one or more human users, as known as “human-in-the-loop” systems. In some embodiments, the user of any of the systems disclosed herein can be a computer system, artificial intelligence (“AI”), cognitive or non-cognitive algorithms, and the like.

The following table is a non-exclusive and non-exhaustive list of examples using any of the systems and methods disclosed herein.

A banking company is facing a compliance audit, and it has been asked
to explain several in-house machine learning models that it has been using
to analyze international markets. Unfortunately, the software engineers
who created the models are no longer with the company.
An insurance company uscs multiple analytical models to produce an
ensemble result used in investigations of insurance fraud. The specific set
of models, and the corresponding weights applied to them, can differ on
a case-by-case basis. In a litigation accosing a client of insurance fraud,
the insurance company must now take their analytical results to court,
where they must be explained.
A finance company uses a machine learning algorithm from a third-party
vendor to detect banking fraud across its user accounts. While the
third-party vendor has supplied basic documentation and training on the
various models used by the machine learning algorithm, the understanding
of the complex results obtained when applying the algorithm over time is
not well understood.

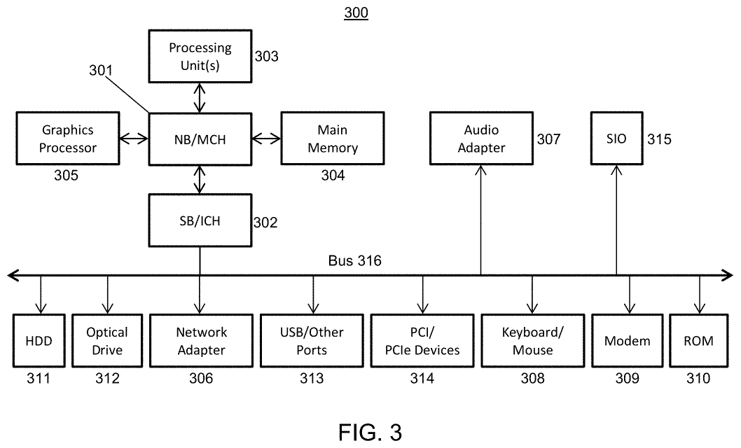

FIG. 3 depicts a block diagram of an example data processing system 300 in which aspects of the illustrative, embodiments are implemented. Data processing system 300 is an example of a computer, such as a sever or client, in which computer usable code or instructions implementing the process for illustrative embodiments of any of the disclosures described herein are located. In some embodiments, FIG. 3 represents a server computing device, such as a server, which implements the system for interpreting analytical results described herein.

In the depicted example, data processing system 300 can employ a hub architecture including a north bridge and memory controller hub (NB/MCH) 301 and south bridge and input/output (I/O) controller hub (SB/ICH) 302. Processing unit 303, main memory 304, and graphics processor 305 can be connected to the NB/MCH 301. Graphics processor 305 can be connected to the NB/MCH through an accelerated graphics port (AGP).

In the depicted example, the network adapter 306 connects to the SB/ICH 302. The audio adapter 307, keyboard and mouse adapter 308, modem 309, read only memory (ROM) 310, hard disk drive (HDD) 311, optical drive (CD or DVD) 312, universal serial bus (USB) ports and other communication ports 313, and the PCI/PCIe devices 314 can connect to the SB/ICH 30. through bus system 316. PCI/PCIe devices 314 may include Ethernet adapters, add-in cards, and PC cards for notebook computers. ROM 310 may be, for example, a flash basic input/output system (BIOS). The HDD 311 and optical drive 312 can use an integrated drive electronics (IDE) or serial advanced technology attachment (SATA) interface. The super I/O (SIO) device 315 can be connected to the SR/ICH.

An operating system can run on processing unit 101. The operating system can coordinate and provide control of various components within the data processing system 300. As a client, the operating system can be a commercially available operating system. An object-oriented programming system, such as the Java™ programming system, may run in conjunction with the operating system and provide calls to the operating system from the object-oriented programs or applications executing on the data processing system 300. As a server, the data processing system 300 can be an IBM® eServer™ System p® running the Advanced Interactive Executive operating system or the Linux operating system. The data processing system 300 can be a symmetric multiprocessor (SMP) system that can include a plurality of processors In the processing unit 303. Alternatively, a single processor system may be employed.

Instructions for the operating system, the object-oriented programming system, and applications or programs are located un storage devices, such as the HDD 311, and are loaded into the main memory 304 for execution by the processing unit 303. The processes for embodiments of the medical record error detection system can be performed by the processing unit 303 using computer usable program code, which can be located in a memory such as, for example, main memory 304, ROM 310, or in one or more peripheral devices.

A bus system 316 can be comprised of one or more busses. The bus system 316 can be implemented using any type of communication fabric or architecture that can provide for a transfer of data between different components or devices attached to the fabric or architecture. A communication unit such as the modem 309 or network adapter 306 can include, one or more devices that can be used to transmit and receive data.

Those of ordinary skill in the art will appreciate that the hardware required to run any of the systems and methods described herein may vary depending on the implementation. Other internal hardware or peripheral devices, such as flash memory, equivalent non-volatile memory, or optical disk drives may be used in addition to or in place of the hardware depicted. Moreover, any of the systems described herein can take the form of any of a number of different data processing systems, including but not limited to, client computing devices, server computing devices, tablet computers, laptop computers, telephone or other communication devices, personal digital assistants, and the like. Essentially, any of the systems described herein can be any known or later developed data processing system without architectural limitation.

The systems and methods of the figures are not exclusive. Other systems, and processes may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

Although the present invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. A computer implemented method in a data processing system comprising a processor and a memory comprising instructions which are executed by the processor to cause the processor to implement a system for interpreting analytical results, the method comprising:
receiving, by the system, input information comprising the analytical results to be interpreted;
determining, by the system, analytic elements of the input information; wherein the analytic elements comprise;
a problem domain of the input information,
key data elements of the input information,
computed features of the input information,
applicable models for the analysis of the input information, and
relevant visualizations of the applicable models;
generating, by the system, the results of the analytic elements;
generating, by the system, an output report on the results of the analytic elements; and
transmitting, by the system, the output report to a user.

2. The method of claim 1, wherein the input information further comprises the problem domain and a data set.

3. The method of claim 2, wherein the data set was used to generate the analytical results to be interpreted.

4. The method of claim 1, wherein computed features of the input information comprise one or more of model complexity, model scope, and model trust.

5. The method of claim 1, wherein the method further comprises the step of consulting, by the system, a knowledge database prior to the step of generating the result of the analytic elements.

6. The method of claim 1, wherein the method further comprises the step of reviewing, by a user, the results of the analytic elements prior to the step of generating an output report on the results of the analytic elements.

7. The method of claim 6, wherein the method further comprises the step of updating, by the system, a knowledge database prior to the step of generating an output report on the result of the analytic elements.

8. The method of claim 1, wherein the step of generating an output report on the results of the analytic elements is performed by a natural language generator.

9. The method of claim wherein the user views the output report via a user interface,

10. A system for interpreting analytical results, comprising:
a result interpreter system;
a natural language generator; and
a memory comprising instructions which are executed by a processor configured to:
receive, by the system for interpreting analytical results, input information comprising the analytical results to be interpreted;
determine, by the result interpreter system, analytic elements of the input information;
generate, by the result interpreter system, the results of the analytic elements;
generate, by the natural language generator, an output report on the results of the analytic elements; and
transmit, by the system for interpreting analytical results, the output report to a user.

11. The system of claim 10, wherein the wherein the analytic elements comprise:
a problem domain of the input information,
key data elements of the input information,
computed features of the input information,
applicable models for the analysis of the input information, and
relevant visualizations of the applicable models.

12. The system of claim 10, wherein the input information further comprises the problem domain and a data set.

13. The system of claim 12, wherein the data set was used to generate the analytical results to be interpreted.

14. The system of claim 10, wherein the computed features of the input information comprise one or more of model complexity, model scope, and model trust.

15. The system of claim 10, wherein the system further comprises the step of consulting, by the result interpreter system, a knowledge database prior to the step of generating the result of the analytic elements.

16. The system of claim 10, wherein the system further comprises the step of reviewing, by a user, the results of the analytic elements prior to the step of generating an output report on the results of the analytic elements.

17. The system of claim 16, wherein the system further comprises the step of updating, by the result interpreter system, a knowledge database prior to the step of generating an output report on the result of the analytic elements.

18. The system of claim 10, wherein the step of generating an output report on the results of the analytic elements is performed by the natural language generator.
